(19) United States
(12) Patent Application Publication
(10) Pub. No.: US 2026/0340629 A1
(43) Pub. Date: Oct. 29, 2026

(54) CONTROLLING BLOCKCHAIN TRANSACTIONS BASED ON FLUCTUATING ASSET VALUES

(71) Applicant: Unstoppable Domains, Inc., Las Vegas, NV (US)

(72) Inventors: Lisa Seacat DeLuca, Bozeman, MT (US); Matthew Gould, Atlanta, GA (US)

(21) Appl. No.: 19/188,416

(22) Filed: Apr. 24, 2025

(51) Int. Cl. G06Q 20/38

(52) U.S. Cl. CPC G06Q 20/389

(57) ABSTRACT

According to a present invention embodiment, a system generates for a user an electronic offer for an item of the computer environment. The electronic offer includes an amount for the item. The system determines that a group of one or more assets of the user has a valuation to satisfy the amount of the electronic offer. The valuation of the group fluctuates over time. The electronic offer is submitted to acquire the item. The group is monitored and the valuation updated over time prior to transfer of the item. A blockchain transaction to transfer the item to the user is controlled based on a comparison of the updated valuation to the amount of the electronic offer. Embodiments of the present invention further include a method and computer program product for transferring items of a computer environment in substantially the same manner described above.

### TECHNICAL FIELD

Present invention embodiments relate to networking and, more specifically, to controlling blockchain transactions for onchain and/or offchain assets (e.g., Web2 or Web3 domains or domain names, ICANN domains or domain names, Domain Name System (DNS) domains or domain names, blockchain domains or domain names, fungible tokens, non-fungible tokens (NFTs), assets of other centralized or decentralized systems, etc.) based on continuous monitoring of fluctuating (or continuously varying) values of assets for the blockchain transactions.

### BACKGROUND

### Discussion of the Related Art

Web2 generally refers to a version of the web (or Internet) that utilizes a centralized Domain Name System (DNS) to translate domain names into corresponding Internet Protocol (IP) addresses in order to access a web site. In contrast, Web3 generally refers to a decentralized version of the web (or Internet) based on blockchains and peer-to-peer networks.

In traditional auctions, a bidder must prove possession of funds to participate in an auction. This is accomplished by providing a proof of funds document that can include a recent bank statement, a letter from a financial institution confirming the available balance of the bidder, or a certified financial statement. These may vary depending on the auction requirements, and essentially demonstrate that the bidder has readily accessible liquid funds to cover the potential purchase price of an item should the bidder be awarded the item.

However, the auction process is slow and error prone. Further, the proof of funds documents provide a valuation of funds at the time of generating the documents. In this case, the valuation provided by the proof of funds documents may not truly reflect a current valuation since the valuation provided by the proof of funds documents may have changed. This is especially true for funds with values that fluctuate constantly.

For example, an auction for an asset on a blockchain may be conducted with cryptocurrency and other assets of a blockchain whose valuation constantly fluctuates. Proof of asset valuation at a certain point in time may not reflect the actual valuation at a subsequent time of acquiring the blockchain asset. This enables improper blockchain transactions to be processed that unnecessarily consume processing resources and suspend the asset. In addition, when execution of an improper blockchain transaction succeeds, it is impossible to reverse (without approval from parties involved in the transaction), thereby enabling invalid transactions to stand.

### SUMMARY

According to one embodiment of the present invention, a system for transferring items of a computer environment comprises one or more memories and at least one processor coupled to the one or more memories. The system generates for a user an electronic offer for an item of the computer environment. The electronic offer includes an amount for the item. The system determines that a group of one or more assets of the user has a valuation to satisfy the amount of the electronic offer. The valuation of the group fluctuates over time. The electronic offer is submitted to acquire the item. The group is monitored and the valuation updated over time prior to transfer of the item. A blockchain transaction to transfer the item to the user is controlled based on a comparison of the updated valuation to the amount of the electronic offer. Embodiments of the present invention further include a method and computer program product (e.g., including one or more computer readable media with instructions executable by one or more processors) for transferring items of a computer environment in substantially the same manner described above.

### BRIEF DESCRIPTION OF THE DRAWINGS

Generally, like reference numerals in the various figures are utilized to designate like components.

FIG. 1 is a diagrammatic illustration of an example computing environment according to an embodiment of the present invention.

FIG. 2 is a block diagram of an example computing device according to an embodiment of the present invention.

FIG. 3 is a procedural flowchart of a method of registering a name or other identifier for an onchain asset (e.g., Web3, blockchain, etc.) based on a name or other identifier for an offchain asset (e.g., Web2, Domain Name System (DNS), etc.) according to an embodiment of the present invention.

FIG. 4 is a procedural flowchart of a method of submitting an offer for transfer of an item according to an embodiment of the present invention.

FIG. 5 is a procedural flowchart of a method of continuously monitoring valuation of assets for a blockchain transaction according to an embodiment of the present invention.

FIG. 6 is a schematic illustration of an example user interface for generating an offer for transferring an item according to an embodiment of the present invention.

FIG. 7 is a schematic illustration of an example user interface providing notification to an acquiring user of insufficient valuation of assets for a blockchain transaction according to an embodiment of the present invention.

FIG. 8 is a schematic illustration of an example user interface providing notification to an initial user of insufficient valuation of assets of an acquiring user for a blockchain transaction according to an embodiment of the present invention.

FIG. 9 is a schematic illustration of an example user interface providing notification to an acquiring user of insufficient valuation of assets for a blockchain transaction according to an embodiment of the present invention.

### DETAILED DESCRIPTION

Web2 generally refers to a version of the web (or Internet) that utilizes a centralized Domain Name System (DNS) to translate domain names into corresponding Internet Protocol (IP) addresses in order to access a web site. Domain Name System (DNS) creates a set of one or more records when a domain name is registered. DNS records (or text files) reside in DNS servers and provide information pertaining to a domain name including an associated IP address and request handling.

In contrast, Web3 generally refers to a decentralized version of the web (or Internet) based on blockchains and peer-to-peer networks.

Marketplaces and brokerage services for (Web2 and/or Web3) domain names facilitate the transfer of the domain names. These platforms help connect owners of domain names with potential users interested in acquiring the domain names and manage the often complex and lengthy transfer process.

Marketplaces for (Web2 and/or Web3) domain names are online or computerized platforms where domain owners list their available domains, and prospective users interested in acquiring domains can search, negotiate, and acquire the domains. These marketplaces provide a transparent and centralized manner for connecting owners with prospective acquirers, and often offer tools that streamline the entire transaction process, including valuation guidance, escrow services, and actual transfer of the domain name.

Owners can list their (Web2 and/or Web3) domain names on these platforms and set a value or select an auction-style listing. Owners may also negotiate directly with interested users when the listing is auction-based. Interested users can browse available domains via keyword searches, category filters, or domain extensions. Marketplaces often provide domain valuation tools to help interested users understand the market value of a domain name.

Some marketplaces allow interested users to acquire domains immediately at a fixed value (typically in the case of premium domains). In other cases, marketplaces enable owners and interested users to negotiate the value, often involving an option for the interested user to provide an offer. The platforms may offer built-in valuation tools to help establish fair market values based on comparable domain transfers.

In traditional auctions, a bidder must prove possession of funds to participate in an auction. This is accomplished by providing a proof of funds document that can include a recent bank statement, a letter from a financial institution confirming the available balance of the bidder, or a certified financial statement. These may vary depending on the auction requirements, and essentially demonstrate that the bidder has readily accessible liquid funds to cover the potential purchase price of an item should the bidder be awarded the item.

However, the auction process is slow and error prone. Further, the proof of funds documents provide a valuation of funds at the time of generating the documents. In this case, the valuation provided by the proof of funds documents may not truly reflect a current valuation since the valuation provided by the proof of funds documents may have changed. This is especially true for funds with values that fluctuate constantly.

For example, an auction for an asset on a blockchain may be conducted with cryptocurrency and other assets of a blockchain whose valuation constantly fluctuates. Proof of asset valuation at a certain point in time may not reflect the actual valuation at a subsequent time of acquiring the blockchain asset. This enables improper blockchain transactions to be processed that unnecessarily consume processing resources and suspend the asset. In addition, when execution of an improper blockchain transaction succeeds, it is impossible to reverse (without approval from parties involved in the transaction), thereby enabling invalid transactions to stand.

Accordingly, an embodiment of the present invention verifies that a user acquiring an item (e.g., onchain and/or offchain asset) possesses assets of sufficient value through onchain and/or offchain asset valuation in order to obtain the item. The embodiment uses onchain and/or offchain portfolios for the verification (e.g., as proof of funding) prior to marketplace offers, and provides continuous monitoring of the onchain and/or offchain assets until the offer is finalized (e.g., accepted, rejected, withdrawn/canceled, etc.). The embodiment may be utilized for an online or computerized platform that allows users to present or submit an offer (e.g., electronically or online) and acquire items (e.g., onchain and/or offchain domains, other assets, etc.). The embodiment verifies that an acquiring user possesses onchain and/or offchain assets of sufficient value to satisfy an amount of an offer (e.g., desired value to be provided by the acquiring user, etc.) prior to allowing the offer to be placed for acquiring an item (e.g., domain or other asset).

An asset may include any item or object, and may be associated with a computer or network environment (e.g., a domain, a domain name, a set of records, an object that points to a set of records, a non-fungible token (NFT), non-fungible token (NFT) domain names, a fungible token, a wallet address, email or other service, communication entity, currency, stocks, equities, physical objects, etc.). An onchain asset may include any asset residing on, or supported by, a blockchain or other decentralized system (e.g., Web3 asset, asset of a decentralized system, asset of a partial or hybrid decentralized system, etc.). An offchain asset may include any asset residing on, or supported by, a centralized system or a system with centralized control (e.g., Web2, Domain Name System (DNS), ICANN accredited domain names, system other than a decentralized system described above, etc.). An offchain asset may further include any tangible or intangible objects maintained outside of a blockchain (e.g., currency, stocks, equities, physical objects, etc.). Transfer of an onchain or offchain asset may include any action or transaction that provides ownership, rights, registration, custody, control, possession, and/or any other interest in the onchain or offchain asset. Further, acquiring or obtaining an onchain or offchain asset may include obtaining ownership, rights, registration, custody, control, possession, and/or any other interest in the onchain or offchain asset.

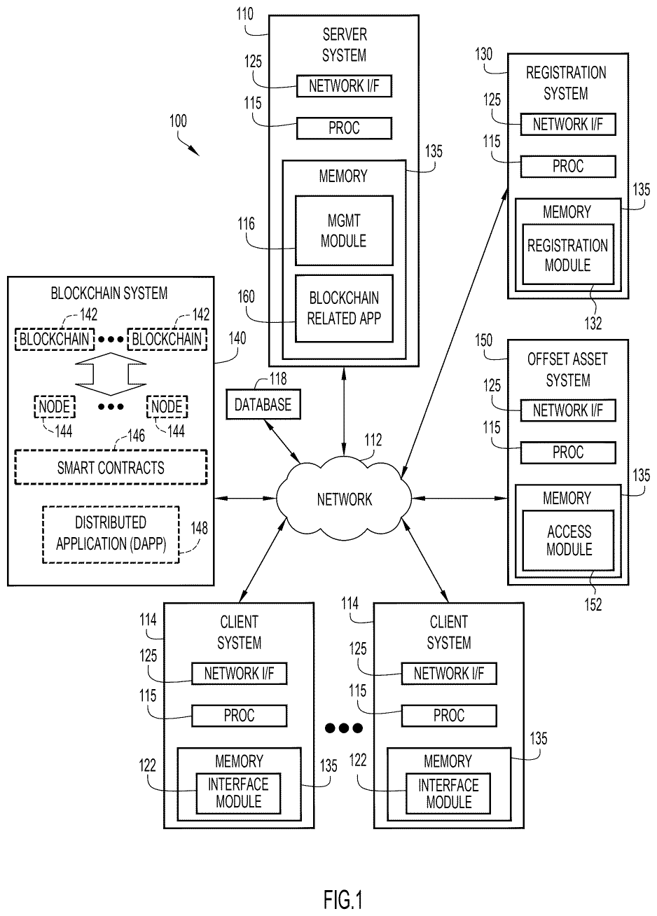

An example environment 100 for use with present invention embodiments is illustrated in FIG. 1. Specifically, environment 100 includes one or more server systems 110, one or more client or end-user systems 114, one or more registration systems 130, one or more blockchain systems 140 each implementing and maintaining at least one corresponding blockchain 142, and one or more offchain asset systems 150. Server systems 110, client systems 114, registration systems 130, blockchain systems 140, and/or offchain asset systems 150 may be remote from each other and communicate over a network 112. The network may be implemented by any number of suitable communications media (e.g., wide area network (WAN), local area network (LAN), Internet, Intranet, etc.). Alternatively, server systems 110, client systems 114, registration systems 130, blockchain systems 140, and/or offchain asset systems 150 may be local to each other, and communicate via any appropriate local communication medium (e.g., local area network (LAN), hardwire, wireless link, Intranet, etc.).

Server systems 110 include a management module 116. Management module 116 may interface with a user via a client system 114, and/or may be of the form of an Application Programming Interface (API) to perform onchain and/or offchain asset management (e.g., for domains or other objects, marketplace or other platforms, etc.). The management module may process requests from any entities (e.g., user, application, service, computing or other device, etc.).

Client systems 114 may include an interface module 122 to provide a graphical user (e.g., GUI, etc.) or other interface (e.g., command line prompts, menu screens, etc.) that enables users to access server systems 110 and blockchain systems 140 for managing onchain and/or offchain assets (e.g., domains or other objects, etc.). The interface module may include any conventional or other browser to access server systems 110 and blockchain systems 140.

Registration systems 130 include a registration module 132 that registers and manages names or other identifiers for offchain assets (e.g., Web2 domains or domain names, ICANN domains or domain names, Domain Name System (DNS) domains or domain names, etc.). By way of example, the registration system may include a conventional or other DNS server and be associated with one or more registrars.

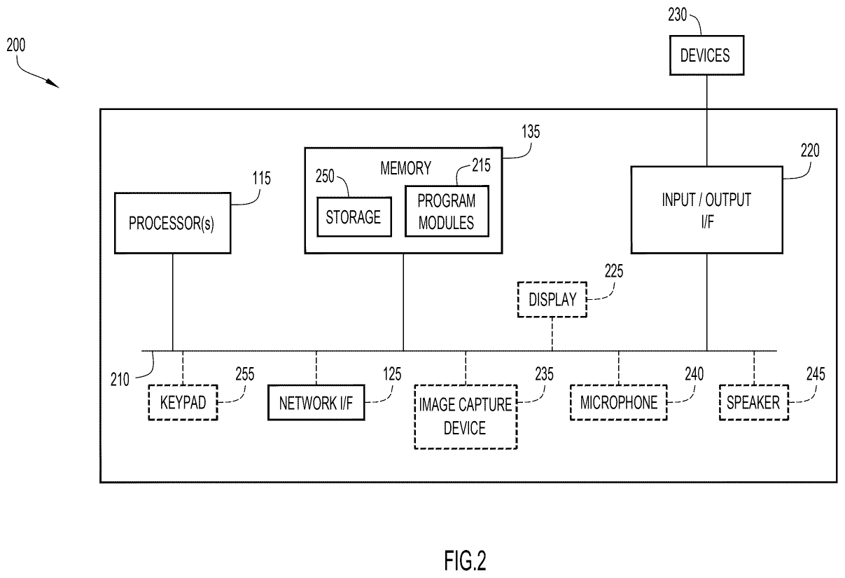

Blockchain systems 140 may each include one or more nodes 144 to implement and maintain at least one corresponding blockchain 142. The nodes may be implemented by any suitable computing devices (e.g., as described below for FIG. 2). The blockchain is generally in the form of a ledger that includes a series of records or blocks chained or linked together. The blockchain is typically managed by a peer-to-peer network (of nodes 144) and used as a distributed ledger. Nodes 144 of the peer-to-peer network communicate and verify new blocks according to a protocol. The peer-to-peer network provides a decentralized approach, where each node has a copy of a blockchain 142. Transactions are transmitted to the peer-to-peer network, where mining nodes (nodes 144) process the transactions. The mining nodes validate a transaction, insert the transaction into a current block, and transmit the block to the other nodes. Blockchain 142 may be implemented by any conventional or other blockchain, and may be a public (e.g., no access restrictions, etc.), private (e.g., restricted access, etc.), or hybrid (e.g., with centralized and decentralized features) blockchain.

Blockchain systems 140 may include one or more distributed or decentralized applications (dApps) 148 to perform various operations (e.g., financial or other transactions or operations related to a blockchain, etc.). In addition, a blockchain 142 may store software (e.g., typically referred to as smart contracts 146) that executes on the blockchain in response to occurrence of pre-defined conditions. The smart contracts may transfer onchain and/or offchain assets as described below. The onchain assets may be associated with the same and/or various different blockchains.

Offchain asset systems 150 include an access module 152 that accesses and manages various financial or other accounts maintaining offchain assets (e.g., bank accounts, stocks or equities, financial instruments, etc.). The offchain asset system may be implemented by any conventional or other systems managing these types of accounts.

Interface module 122 of client systems 114 may further provide a graphical user (e.g., GUI, etc.) or other interface (e.g., command line prompts, menu screens, etc.) that enables users to access decentralized applications (dApps) 148 and/or smart contracts 146 on blockchain systems 140 for performing various operations (e.g., financial or other transactions or operations related to a blockchain, etc.). The interface module may include any conventional or other browser to access the decentralized applications (dApps) of blockchain systems 140. The interface module may natively, or include extensions to, access the decentralized applications (dApps) and/or other components of blockchain system 140. The interface module may provide a user interface to serve as a front end for a decentralized application (dApp) 148, where back end processing for the decentralized application (dApp) is performed on a blockchain system 140. Client systems 114 may further provide reports or notifications pertaining to requests from users (e.g., results of a transaction, transfers of onchain and/or offchain assets, etc.).

Server systems 110 further include one or more blockchain related applications 160 for performing various operations (e.g., transactions or operations related to a blockchain, access asset information based on an associated asset, etc.). Management module 116 and blockchain related applications 160 may be on the same or different server systems 110. The blockchain related application may process requests from any entities (e.g., user, application, service, computing or other device, etc.).

A database or offchain storage system 118 may store various information for a blockchain asset (e.g., blockchain asset information, mappings of blockchain assets to blockchains, blockchain domain content, etc.). The database system may be implemented by any conventional or other database or offchain storage unit (e.g., Interplanetary File System (IPFS), etc.), may be local to or remote from server systems 110, client systems 114, registration systems 130, and/or blockchain systems 140, and may communicate via any appropriate communication medium (e.g., local area network (LAN), wide area network (WAN), Internet, hardwire, wireless link, Intranet, etc.).

Server systems 110, client systems 114, registration systems 130, and offchain asset systems 150 may be implemented by any conventional or other computer systems preferably equipped with a display or monitor, a base, optional input devices (e.g., a keyboard, mouse or other input device), and any software for use by present invention embodiments (e.g., server/communications software, blockchain software, management module 116, interface module 122, registration module 132, access module 152, blockchain related applications 160, etc.). The base may include at least one hardware processor 115 (e.g., microprocessor, controller, central processing unit (CPU), etc.), one or more memories 135, and/or internal or external network interfaces or communications devices 125 (e.g., modem, network cards, etc.)).

Management module 116, interface module 122, registration module 132, smart contracts 146, decentralized applications (dApps) 148, access module 152, and blockchain related applications 160 may include one or more modules or units to perform the various functions of present invention embodiments described below. The various modules (e.g., management module 116, interface module 122, registration module 132, access module 152, blockchain related applications 160, etc.) may be implemented by any combination of any quantity of software and/or hardware modules or units, and may reside within memory 135 of the server, client, registration, and/or offchain asset systems for execution by a corresponding processor 115. The various modules of the blockchain (e.g., smart contracts 146, decentralized applications (dApps) 148, etc.) may be implemented by any combination of any quantity of software and/or hardware modules or units, and may reside on a blockchain 142 for execution by one or more nodes 144.

An example of a computing device 200 for environment 100 (e.g., implementing server systems 110, client systems 114, registration systems 130, blockchain systems 140, nodes 144, offchain asset systems 150, etc.) is illustrated in FIG. 2. The example computing device may perform the functions of present invention embodiments described herein. Computing device 200 may be implemented by any personal or other type of computer or processing system (e.g., desktop, laptop, hand-held device, smartphone or other mobile device, etc.), and may be used for any computing environments (e.g., cloud computing, client-server, network computing, mainframe, stand-alone systems, etc.).

Computing device 200 may include one or more processors 115 (e.g., microprocessor, controller, central processing unit (CPU), etc.), network interface 125, memory 135, a bus 210, and an Input/Output interface 220. Bus 210 couples these components for communication, and may be of any type of bus structure, including a memory bus or memory controller, a peripheral bus, and a processor or local bus using any of a variety of conventional or other bus architectures. Memory 135 is coupled to bus 210 and typically includes computer readable media including volatile media (e.g., random access memory (RAM), cache memory, etc.), non-volatile media, removable media, and/or non-removable media. For example, memory 135 may include storage 250 containing non-removable, non-volatile magnetic or other media (e.g., a hard drive, etc.). The computing device may further include a magnetic disk drive and/or an optical disk drive (not shown) (e.g., CD-ROM, DVD-ROM or other optical media, etc.) connected to bus 210 via one or more data interfaces.

Moreover, memory 135 includes a set of program modules 215 (e.g., corresponding to management module 116, interface module 122, registration module 132, blockchain software (e.g., smart contracts 146, decentralized applications (dApp) 148, blockchain management software, etc.), access module 152, blockchain related applications 160, network site or service software, etc.) that are configured to perform functions of present invention embodiments described herein. The memory may further include an operating system, at least one application and/or other modules, and corresponding data. These may provide an implementation of a networking environment.

Input/Output interface 220 is coupled to bus 210 and communicates with one or more peripheral or external devices 230 (e.g., a keyboard, mouse or other pointing device, a display, sensing devices, etc.), at least one device that enables a user to interact with computing device 200, and/or any device (e.g., network card, modem, etc.) that enables computing device 200 to communicate with one or more other computing devices. Computing device 200 may communicate with one or more networks (e.g., a local area network (LAN), a wide area network (WAN), a public network (e.g., the Internet), etc.) via network interface 125 coupled to bus 210.

With respect to certain entities (e.g., client system 114, etc.), computing device 200 may further include, or be coupled to, a touch screen or other display 225, a camera or other image capture device 235, a microphone or other sound sensing device 240, a speaker 245 to convey sound, and/or a keypad or keyboard 255 to enter information (e.g., alphanumeric information, etc.). These items may be coupled to bus 210 or Input/Output interface 220 to transfer data with other elements of computing device 200.

Initially, a blockchain (e.g., blockchain 142, etc.) is generally in the form of a ledger that includes a series of records or blocks chained or linked together. Each block includes a hash of the prior block in the blockchain, a timestamp, and transaction information. The hash of the prior block enables the blockchain to be resistant to modification since changes to data in any prior block alter the hash value which propagates to subsequent blocks.

A blockchain is typically managed by a peer-to-peer network and used as a distributed ledger. Nodes of the peer-to-peer network communicate and verify new blocks according to a protocol. The peer-to-peer network provides a decentralized approach, where each node has a copy of the blockchain. Transactions are transmitted to the network, where mining nodes process the transactions. The mining nodes validate a transaction, insert the transaction into a current block, and transmit the block to the other nodes. Various consensus approaches may be used for combining validation results of different mining nodes to determine validity of a transaction (or block).

Users of transactions for the blockchain are authenticated based on cryptographic keys. These keys identify a user and provide access to a user wallet. The user wallet is basically an application or software that enables users to store and access digital assets (e.g., for receiving or sending cryptocurrency or other fungible tokens, non-fungible tokens (NFTs), etc.). For example, a non-fungible token (NFT) is a crypto type asset with each token being unique (and representing items, such as digital art, music, or video game items), whereas fungible tokens (e.g., coins of the same cryptocurrency) have the same value of worth and are exchangeable. Each user is associated with their own private key (e.g., accessible only to the associated user, etc.) and a public key (e.g., typically an address on the blockchain). The private and public keys enable authentication of the user based on digital signatures in order to commence a transaction. The user wallet typically stores the private key.

For example, in order for the user to send cryptocurrency, a message for a transaction is encrypted (or signed) using the private key of the user wallet. The private key enables only the user to control the user wallet. A digital signature is created by encrypting the message with the private key, where the digital signature is used to verify the user and transaction. The message may be decrypted with the corresponding public key of the user wallet. Since the private key is unique to the user, successful decryption of the message with the corresponding public key verifies the message was sent by the user. Once verified, the transaction may be posted to the blockchain, thereby adjusting the user account based on the transaction.

In addition, a blockchain may store software (e.g., smart contracts 146) that executes in response to occurrence of pre-defined conditions. A smart contract is generally software or a program that runs on the blockchain. The code and data for the smart contract reside at a specific address on the blockchain. Non-fungible tokens (NFTs) are controlled by smart contracts that handle transference and verification of ownership of the non-fungible tokens (NFTs). A blockchain may be public (e.g., no access restrictions, etc.), private (e.g., restricted access, etc.), or hybrid (e.g., with centralized and decentralized features).

A blockchain domain name is stored on a blockchain. A blockchain domain name may be a non-fungible token (NFT) domain name that is associated with a non-fungible token (NFT) stored in a user wallet account. The blockchain domain name may be associated with various information (e.g., wallet addresses or accounts, user information (e.g., name, address, email, etc.), data or other access restrictions, etc.). The blockchain domain name is associated with software or smart contracts on the blockchain that may perform various functions (e.g., provide a registry for corresponding wallet addresses, indicate locations of content for the domain (e.g., or a website, etc.) hosted on the blockchain or other system, etc.). In order to access a blockchain domain, the blockchain is accessed to find the record corresponding to the blockchain domain name (which may initiate the corresponding smart contracts for the corresponding functionality). The private key of the user wallet enables the user to have sole control of the blockchain domain (e.g., authenticating operations or transactions for the blockchain domain name similar to the cryptocurrency example described above, etc.). For example, the user may have sole control to perform operations that alter content and/or functionality for the blockchain domain.

An embodiment of the present invention may be utilized for an online or computerized platform that allows users to present an offer (e.g., electronically or online) and acquire items (e.g., onchain and/or offchain domains, other assets, etc.). The embodiment verifies that an acquiring user possesses onchain and/or offchain assets of sufficient value to satisfy an amount of an offer (e.g., value desired to be provided by the acquiring user, etc.) prior to allowing the offer to be placed for acquiring an item (e.g., domain or other asset). Onchain and/or offchain portfolios are used for verification (e.g., proof of funding) of offers prior to placing the offers, and continuous monitoring of onchain and/or offchain assets is employed until an offer is finalized. The value of assets of an acquiring user are verified in order to allow generation (or placement) of an offer for an item of the online platform.

Transfer of an onchain or offchain asset may include any action or transaction that provides ownership, rights, registration, custody, control, possession, and/or any other interest in the onchain or offchain asset. Further, acquiring or obtaining an onchain or offchain asset may include obtaining ownership, rights, registration, custody, control, possession, and/or any other interest in the onchain or offchain asset.

By way of example, an onchain asset may be a non-fungible token (NFT) representing a corresponding onchain version of an offchain domain name (or tokenized version of the offchain domain name). An offchain domain name (e.g., Web2 domain or domain name, ICANN domain or domain name, Domain Name System (DNS) domain or domain name, etc.) may be tokenized as an NFT or other onchain representation by a blockchain service or smart contract. The online or computerized platform may list various items available for transfer (e.g., an onchain asset, an offchain asset, an item having a combination of onchain and offchain assets (e.g., a tokenized domain name and the corresponding offchain domain name, etc.), etc.).

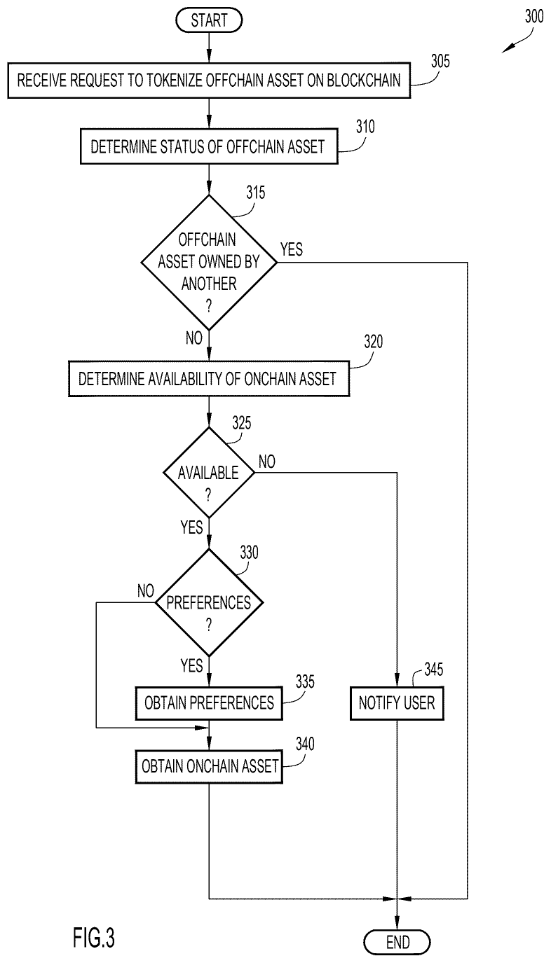

A method 300 of registering a name or other identifier for an onchain asset (e.g., Web3, blockchain, etc.) based on a name or other identifier for an offchain asset (e.g., Web2, Domain Name System (DNS), etc.) (e.g., via management module 116, registration module 132, smart contract 146, decentralized application (dApp) 148, blockchain related application 160, server system 110, client system 114, registration system 130, and/or blockchain system 140) according to an embodiment of the present invention is illustrated in FIG. 3. Initially, a user may register, or desire to register, a name or other identifier of an offchain asset (e.g., Web2, ICANN, Domain Name System (DNS), etc.) for an onchain asset (e.g., Web3, blockchain, non-fungible token (NFT), etc.) via management module 116. An asset may include any item or object, and may be associated with a computer or network environment (e.g., a domain, a domain name, a set of records, an object that points to a set of records, a non-fungible token (NFT), non-fungible token (NFT) domain names, a fungible token, a wallet address, email or other service, communication entity, currency, stocks, equities, physical objects, etc.). An onchain asset may include any asset residing on, or supported by, a blockchain or other decentralized system (e.g., Web3 asset, asset of a decentralized system, asset of a partial or hybrid decentralized system, etc.). An offchain asset may include any asset residing on, or supported by, a centralized system or a system with centralized control (e.g., Web2, Domain Name System (DNS), ICANN accredited domain names, system other than a decentralized system described above, etc.). An offchain asset may further include any tangible or intangible objects maintained outside of a blockchain (e.g., currency, stocks, equities, physical objects, etc.). The name or other identifier for the offchain and onchain assets (e.g., with respect to NFTs and domains, etc.) may include a name portion and an optional extension (e.g., “name.e1”, etc.). Alternatively, the name or other identifier may include the name portion without the extension. The name portion and extension may each include any quantity of terms, words, tokens, or arrangements of any quantity of any types of elements (e.g., alphanumeric or other characters, symbols, numbers, etc.). A user may include, or be associated with, any type of entity (e.g., individual, company, organization, decentralized autonomous organization (DAO), etc.).

Management module 116 receives a request for the name or other identifier of the offchain asset to tokenize (or create a corresponding non-fungible token (NFT) for) the offchain asset on a blockchain at operation 305. The management module may receive and process requests from any entities (e.g., user, application, service, computing or other device, client system 114, etc.). The management module performs a look-up of the name of the offchain asset at operation 310 to determine registration/ownership of the offchain asset by another user (e.g., indicating unavailability of the offchain asset). By way of example, the offchain asset may include an offchain domain name (e.g., Web2, Domain Name System (DNS), etc.), and management module 116 requests information (e.g., DNS records, etc.) for the offchain domain name from registration system 130. The information from the registration system indicates registration/ownership or availability of the offchain asset.

When the offchain asset is not registered/owned by another user as determined at operation 315, management module 116 determines availability of the name of the offchain asset for an onchain asset at operation 320. In other words, management module 116 determines availability of an onchain representation of the offchain asset. For example, the management module (e.g., via blockchain related application 160) accesses an intended blockchain 142 for the onchain version (e.g., via a blockchain system 140), and performs a look-up for the name of the offchain asset on the blockchain. Absence of a record on the blockchain for the name indicates the name for the offchain asset (or onchain version) is available on the blockchain. Further, management module 116 may perform a look-up for the name (e.g., on a blockchain, marketplace, etc.) to determine availability of the onchain asset for transfer from another user. The intended blockchain may be selected by a user, and the name for the look-up may include the name portion of the name of the offchain asset (e.g., with the same extension, a corresponding extension for the intended blockchain, etc.).

When an onchain representation of the offchain asset is available as determined at operation 325, payment and other preferences may be provided or selected for acquiring the onchain version (e.g., tokenizing the offchain asset on the blockchain). The options or preferences may include payment to acquire the onchain representation, an intended blockchain or other system to publish or mint the onchain version, a smart contract for the transaction, etc. When preferences are required as determined at operation 330, management module 116 obtains the preferences at operation 335. The preferences may be stored offchain in database system 118, or received from an administrator.

The name for the onchain version is acquired at operation 340. For example, management module 116 (e.g., via blockchain related application 160, corresponding smart contract 146, and/or decentralized application (dApp) 148) publishes or mints the name for the onchain version (e.g., represented by a non-fungible token (NFT)) on a corresponding blockchain, and/or transfers the onchain asset from a current owner to the user (e.g., places the onchain asset in a user wallet account). The acquisition of the onchain version may be performed based on any required preferences. This may be accomplished by management module 116 (e.g., via blockchain related application 160, corresponding smart contract 146, and/or decentralized application (dApp) 148) providing a transaction to the blockchain indicating acquisition of the onchain version (or NFT) by the user. In addition, various information for the onchain version (e.g., user information, asset information, wallet information, etc.) may be stored onchain and/or in offchain storage (e.g., database system 118, etc.).

The offchain and onchain versions may be linked based on the name or other identifier. For example, management module 116 (e.g., via registration module 132 of registration system 130) may set a record associated with the offchain asset to indicate the onchain representation. By way of example, a Domain Name System (DNS) canonical name or other record may be created or modified to include an identifier for the onchain asset (e.g., onchain domain name, wallet address, etc.).

Further, management module 116 (e.g., via decentralized application (dApp) 148 and/or blockchain related application 160) may set or update records associated with the onchain asset to indicate information for the offchain asset. For example, an onchain or offchain record may be created or modified to include an identifier for the offchain asset (e.g., an offchain domain name to be linked, IP address, registry, etc.).

Once the onchain and offchain representations are acquired, transactions may be conducted (e.g., via management module 116 and/or blockchain related application 160) using the names for the onchain or offchain assets. For example, the information in the records for the offchain domain may be used to resolve data for the onchain representation (e.g., a user may send cryptocurrency to an offchain domain (based on an associated record indicating the onchain domain), etc.). The transaction may be analyzed to determine the actions, underlying system, and the corresponding representation needed for that system. By way of example, when the transaction is for an onchain representation (or domain) for an onchain system using an offchain representation (or domain), a lookup of the Domain Name System (DNS) canonical name or other record associated with the offchain representation (e.g., Web2/offchain/DNS version of the onchain domain) is performed to obtain the onchain representation for conducting the transaction. A similar approach may be used for offchain transactions using onchain representations.

Further, transactions conducted for an onchain or offchain representation may automatically be applied to the linked (offchain or onchain) representation. By way of example, selling an offchain representation also sells the linked onchain representation (and vice versa), transferring the onchain representation also transfers the linked offchain representation (and vice versa), making available for auction the onchain representation also makes the linked offchain representation available (and vice versa), purchasing an offchain representation brand new also purchases the linked onchain representation (and vice versa), taking out a loan may apply to the linked representations or be conducted using one of the linked representations, extending expiration of (or renewing) an offchain representation extends (or renews) the registration for a linked onchain representation (and vice versa), and/or transferring an offchain domain to a new registrar (in the case of domains) transfers the onchain domain to the new registrar (or vice versa) or the transfer may be conducted using one of the linked representations.

When the onchain asset is not available based on the look-up (e.g., an onchain representation of the offchain asset is already owned by the user or by another user that is not making the onchain asset available for transfer) as determined at operation 325, management module 116 alerts or notifies the user at operation 345. The notification may indicate ownership information for the onchain version of the offchain asset (e.g., the user or other user owning the onchain asset, etc.), and may be presented on a client system 114 (e.g., via interface module 122, etc.).

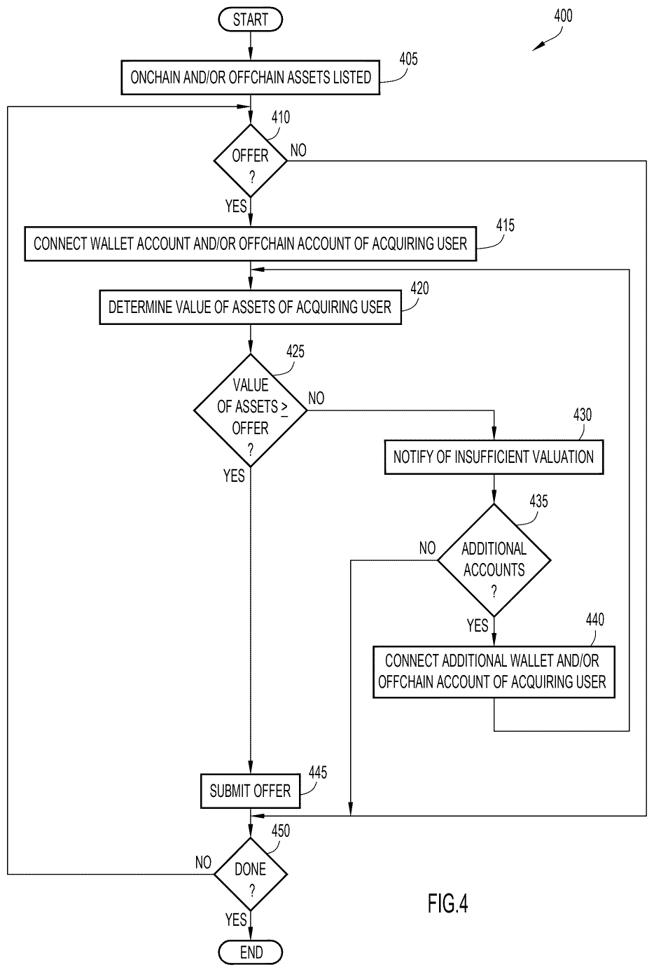

A method 400 of submitting an offer for an item listed on an online or computerized platform (e.g., via management module 116, registration module 132, smart contract 146, decentralized application (dApp) 148, access module 152, blockchain related application 160, server system 110, client system 114, registration system 130, blockchain system 140, and/or offchain asset system 150) according to an embodiment of the present invention is illustrated in FIG. 4. By way of example, the item may include an onchain asset (e.g., non-fungible token (NFT), NFT representing an offchain asset, etc.), an offchain asset (e.g., Web2, ICANN, or Domain Name System (DNS) domain or domain name, etc.), or a combination of onchain and offchain assets (e.g., a tokenized version of an offchain domain name and the corresponding offchain domain name, etc.). However, any onchain and offchain assets may be used in substantially the same manner described below.

The items (e.g., onchain and/or offchain assets) are listed on a computerized platform (e.g., marketplace, etc.) at operation 405. This may be performed by management module 116 via any conventional or other techniques. An acquiring user desires to present an offer for acquiring a listed item. The offer preferably includes an electronic offer initiated on the computerized platform (e.g., via a user interface of a client system 114). When an offer is initiated as determined at operation 410 (e.g., detecting actuation of an offer actuator from the user interface, etc.), the acquiring user is verified with respect to possessing assets of sufficient value to satisfy a value for the item indicated in the offer. For example, when the acquiring user provides an offer of $200,000 for the item, the verification performs a valuation to determine whether the acquiring user possesses assets having a value of at least $200,000.

Management module 116 connects to a wallet account indicated by the acquiring user (e.g., on a user interface of a client system 114) to verify onchain assets at operation 415. This may be accomplished via a wallet signature proving ownership of the wallet account by the acquiring user. For example, the acquiring user may sign a message (e.g., via a client system 114 and initiated via smart contract 146 through management module 116, decentralized application (dApp) 148, blockchain related application 160, etc.) within a wallet account to be used for the offer. Signing of the message in a crypto wallet account (e.g., custodied, self-custody, etc.) generates a digital signature of the message based on the private key of the wallet account. The signed message or digital signature is decrypted for verification (e.g., by an add-on or plug-in of interface module 122 of client system 114) based on a public key (e.g., blockchain address, etc.) corresponding to the wallet account. Since the private key is unique to the wallet account, successful decryption of the message with the corresponding public key verifies the message was signed by the acquiring user. A response may be provided (e.g., from the add-on or plug-in of interface module 122) indicating a result of the decryption of the signed message which may be sent to management module 116 (e.g., via decentralized application (dApp) 148, blockchain related application 160, etc.).

In addition, the verification may be based on offchain assets, or a combination of onchain and offchain assets (e.g., a bank or other financial account may be connected with an offchain balance, a DNS domain name, etc.). For example, management module 116 may connect to or access various online accounts indicated by the acquiring user (e.g., on a user interface of a client system 114) and containing funds or other assets (e.g., bank or other financial accounts, stock or equity portfolios, DNS domains, etc.) to verify offchain assets of the acquiring user at operation 415. These offchain accounts may be accessed by the management module (e.g., via registration module 132 of registration system 130 for offchain domains, via access module 152 of offchain asset system 150 for financial accounts, etc.) to determine the valuation for the offchain assets of the acquiring user. The acquiring user may provide various credentials and/or authorization to access the offchain accounts (e.g., username, password, security token, etc.).

Once the wallet account and/or offchain accounts are connected, management module 116 (e.g., via smart contracts 146, decentralized application (dApp) 148, and/or blockchain related application 160, etc.) determine a valuation of the onchain and/or offchain assets at operation 420. The valuation may be determined based on a sum of the values of the individual onchain and/or offchain assets of the connected wallet and/or offchain accounts. The management module scans the connected wallet account for onchain assets to determine a valuation of the onchain assets. Management module 116 retrieves and analyzes corresponding blockchain transactions for the onchain assets from a corresponding blockchain 142 to determine the valuation of the onchain assets.

By way of example, the onchain assets of the wallet account may be determined by searching transactions on a corresponding blockchain indicating acquisition of onchain assets by the wallet account. Management module 116 (e.g., via smart contracts 146, decentralized application (dApp) 148, and/or blockchain related application 160) accesses an intended blockchain 142 for the onchain assets (e.g., via a blockchain system 140), and performs a look-up for the onchain assets on the blockchain. The transactions corresponding to the onchain assets are retrieved and analyzed to determine the valuation.

The valuation of the onchain assets of the connected wallet account may be performed using any conventional or other valuation tools or techniques. By way of example, the valuation may be determined based on a current value of cryptocurrency (or other fungible tokens) within the connected wallet account and/or a predicted valuation of non-fungible tokens (NFTs) within the wallet account. The value of the cryptocurrency may be ascertained based on information from various data sources (e.g., conventional or other network sites providing cryptocurrency values, etc.). The value of the non-fungible tokens (NFTs) may be ascertained from the purchase price and/or based on value information from various conventional or other marketplaces or other computerized platforms (e.g., floor prices (e.g., minimum offer or requested price, etc.) for the NFTs, prices for NFTs from their NFT communities, etc.).

In addition, the valuation may be based on offchain assets, or a combination of onchain and offchain assets (e.g., a bank account may be connected with an offchain balance, a DNS domain name, etc.). For example, management module 116 may access various online accounts containing funds or other assets (e.g., bank or other financial accounts, stock or equity portfolios, domains, etc.). These offchain accounts may be accessed (e.g., via registration module 132 of registration system 130 for offchain domains, via access module 152 of offchain asset system 150 for financial accounts, etc.) to determine the valuation for the offchain assets of the acquiring user. Further, the value of an offchain asset (e.g., DNS domain name, etc.) may be ascertained from a purchase price and/or based on value information from various conventional or other marketplaces or other computerized platforms. Thus, the valuation may be determined based on values of onchain assets (e.g., cryptocurrencies, non-fungible tokens (NFTs), etc.) and/or offchain assets (e.g., domains, financial accounts, etc.) of the acquiring user. The valuation may be determined and presented or displayed to the acquiring user (on a user interface of a client system 114).

When the valuation satisfies the value indicated in the offer for the item (e.g., the valuation is greater than or equal to the value indicated in the offer, etc.) as determined at operation 425, management module 116 submits the offer at operation 445. Further, the management module may present or display the submitted offer on the computerized platform (e.g., for auction scenarios, etc.).

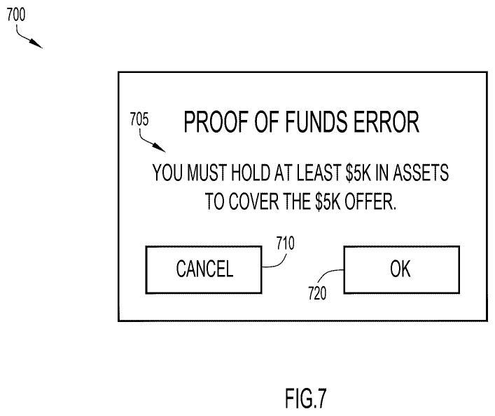

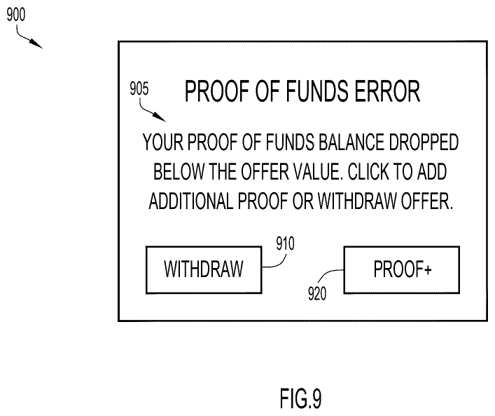

When the valuation does not satisfy the value indicated in the offer for the item (e.g., the valuation is less than the value indicated in the offer, etc.) as determined at operation 425, management module 116 presents or displays (via a client system 114) an error message (e.g., as shown in FIG. 7) to the acquiring user (via a client system 114), and prevents submission of the offer at operation 430. Management module 116 may provide the acquiring user with an opportunity to add an additional wallet account with onchain assets and/or additional offchain accounts with offchain assets (e.g., as shown in FIG. 9) to increase the valuation and compensate for the deficiency.

When an additional wallet account and/or offchain account of the acquiring user is to be provided as determined at operation 435, management module 116 connects to the additional wallet account and/or offchain account at operation 440 in substantially the same manners described above.

The process repeats from operation 420 to determine the valuation of the onchain assets and/or offchain assets in the connected wallet and/or offchain accounts of the acquiring user in substantially the same manner described above. For example, management module 116 (e.g., via smart contracts 146, decentralized application (dApp) 148, and/or blockchain related application 160, etc.) scans the connected wallet accounts by the acquiring user for onchain assets, and retrieves and analyzes corresponding blockchain transactions for the onchain assets to determine a valuation of the onchain assets in substantially the same manner described above.

Management module 116 may access various offchain accounts containing funds or other assets (e.g., bank or other financial accounts, stock or equity portfolios, etc.) to determine a valuation of the offchain assets in substantially the same manner described above. Thus, the valuation may be determined based on values of onchain assets (e.g., cryptocurrencies, non-fungible tokens (NFTs), etc.) and/or offchain assets (e.g., domains, financial accounts, etc.) of the acquiring user.

The above process repeats from operation 420 until the valuation satisfies the value indicated in the offer for the item as determined at operation 425, or no additional wallets or offchain accounts are provided as determined at operation 435.

When an offer is not initiated as determined at operation 410, the offer is submitted at operation 445, or no additional wallets or offchain accounts are provided at operation 435, the process repeats from operation 410 until potential offers are processed as determined at operation 450.

The values of a group or set of onchain and/or offchain assets indicated by the user (e.g., within wallet and/or offchain accounts, etc.) may fluctuate or change over time, thereby enabling the valuation to similarly fluctuate or change over time. For example, the values of cryptocurrency, non-fungible tokens (NFTs), stocks or equities, etc. may fluctuate or change over time. Further, an acquiring user may conduct various activities within the group or accounts (e.g., transfer of assets, acquire assets, withdrawal of funds, etc.) that cause the valuation to fluctuate over time. Since an offer is typically not immediately accepted, there may exist a time interval between submission and acceptance of the offer. Thus, an initial valuation at offer initiation may fluctuate and no longer satisfy the amount of the offer during this time interval.

Accordingly, an embodiment of the present invention continuously or continually monitors a group or set of onchain and/or offchain assets indicated by the acquiring user (e.g., the connected wallet and/or offchain accounts provided by the acquiring user, etc.) until the offer is finalized (e.g., accepted, rejected, withdrawn/canceled, etc.). The monitoring may be performed at any desired time intervals (e.g., periodically (e.g., every quantity of seconds, minutes, etc.), at specific times, based on a schedule, etc.). When the valuation of the group of onchain and/or offchain assets of the wallet and/or offchain accounts provided by the acquiring user drops below the value indicated in the offer at any time prior to finalization of the offer, the offer is placed on hold and can no longer be accepted by the initial user. Further, the acquiring user is alerted of the insufficient valuation, and may add additional onchain and/or offchain assets to the group (e.g., additional wallet and/or offchain accounts, etc.) to remedy the deficiency.

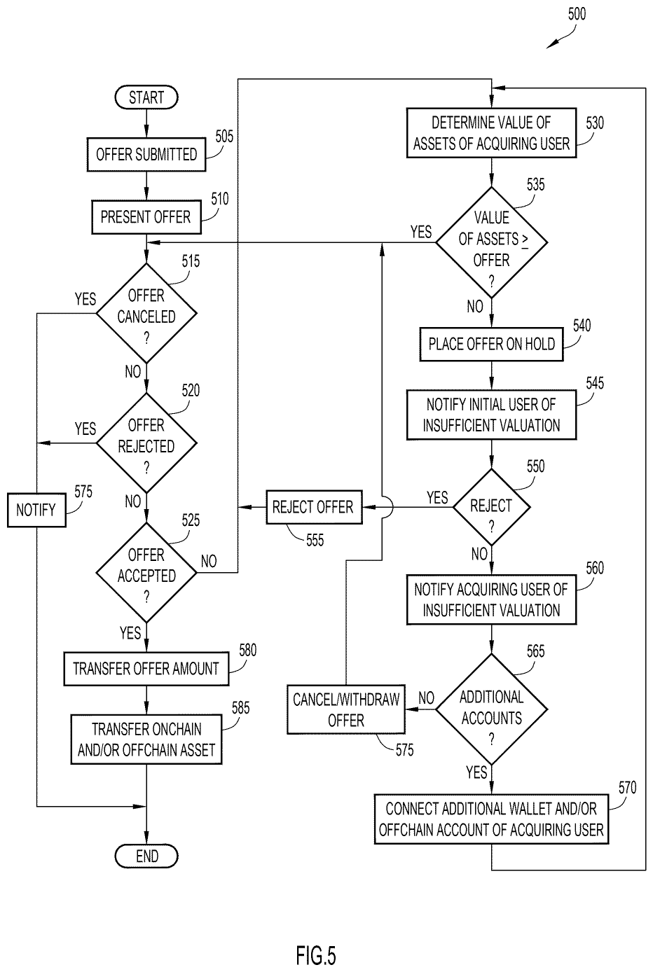

A method 500 of continuously monitoring valuation of assets for a blockchain transaction for an item listed on a computerized platform (e.g., via management module 116, registration module 132, smart contract 146, decentralized application (dApp) 148, access module 152, blockchain related application 160, server system 110, client system 114, registration system 130, blockchain system 140, and/or offchain asset system 150) according to an embodiment of the present invention is illustrated in FIG. 5. An initial user may list an item on the computerized platform (e.g., via management module 116), and an acquiring user may provide an offer for the item at operation 505 in substantially the same manner described above (FIG. 4). By way of example, the item may include an onchain asset (e.g., non-fungible token (NFT), NFT representing an offchain asset, etc.), an offchain asset (e.g., Web2, ICANN, or Domain Name System (DNS) domain or domain name, etc.), or a combination of onchain and offchain assets (e.g., a tokenized version of an offchain domain name and the corresponding offchain domain name, etc.). However, any onchain and offchain assets may be used in substantially the same manner described below.

Management module 116 presents or displays the offer from the acquiring user on the computerized platform at operation 510. This may be accomplished by the management module via any conventional or other techniques. Further, management module 116 may provide or display additional context about the strength of the offer. For example, the management module may provide a confidence score indicating a likelihood the acquiring user can satisfy the value or amount indicated in the offer. The initial user may utilize the confidence score as a basis to reject or accept an offer. The confidence score may include a percentage or probability indicating a likelihood that the group of assets (e.g., of the wallet and/or offchain accounts) provided by the acquiring user have a valuation at the time of acceptance of the offer satisfying the value indicated in the offer. The confidence score may be determined based on various factors, including a difference between the valuation and value indicated in the offer, a length of time a connected wallet account or offchain account has been active, activity or frequency of asset additions/withdrawals within the onchain and/or offchain account, volatility or fluctuation in asset holdings, and/or a trust score of the connected wallet account.

By way of example, a greater difference between the valuation and value indicated in the offer provide a higher confidence score, while a lesser difference provides a lower confidence score. The confidence score may be based on the volatility of the onchain and/or offchain assets relative to the difference. The volatility may be determined from historical data via any conventional or other tools or techniques. Further, newer wallet or offchain accounts may provide a lower (or reduce the) confidence score (due to fraud concerns). Frequent withdrawals or other asset activity within wallet or offchain accounts may indicate greater account volatility and/or fraud concerns and provide a lower confidence score. This may be determined from historical data via any conventional or other techniques (e.g., a quantity of transactions in a time interval, time between transactions, etc.).

Moreover, volatile assets (e.g., non-fungible tokens (NFTs), certain cryptocurrencies, a volatile meme coin holding, stocks or equities, etc.) may provide a lower confidence score since the values are likely to change, while non-volatile or more stable assets provide a higher confidence score. The volatility may be determined based on historical values of the assets via any conventional or other tools or techniques. The confidence score may be based on a percentage of volatile assets within the wallet and/or offchain accounts. The trust score may be obtained from various online or other data sources, and indicates a trustworthiness of the wallet account (e.g., with respect to activity or transactions, etc.). The various factors may be combined in any fashion to produce the confidence score (e.g., summed, averaged, weighted sum or average, etc.). The confidence score may be normalized to any desired range (e.g., 0-1, 0-100, etc.).

The values and/or ownership of the onchain and/or offchain assets may fluctuate or change over time, thereby enabling the valuation to similarly fluctuate or change over time. Since an offer is typically not immediately accepted, there may exist a time interval between submission and acceptance of the offer. Thus, an initial valuation at offer initiation may fluctuate and no longer satisfy the amount of the offer during this time interval.

Accordingly, the group of onchain and/or offchain assets (e.g., connected wallet and/or offchain accounts) provided by the acquiring user are continuously or continually monitored until the offer is finalized (e.g., accepted, rejected, withdrawn/canceled, etc.). When the valuation of the group of onchain and/or offchain assets (e.g., of the wallet and/or offchain accounts) provided by the acquiring user drops below the value indicated in the offer at any time prior to finalization of the offer, the offer is placed on hold and can no longer be accepted by the initial user. Further, the acquiring user is alerted of the insufficient valuation, and may add additional onchain and/or offchain assets (e.g., wallet and/or offchain accounts) to the group to remedy the deficiency.

For example, when an offer from an acquiring user is canceled or withdrawn (e.g., detection of actuation of a cancel actuator on a user interface of a client system 114) as determined at operation 515, management module 116 notifies the initial user of the cancelation at operation 575. The notification may indicate any information pertaining to the offer or cancelation (e.g., time of the cancelation, reason for the cancelation obtained from the acquiring user, etc.), and may be presented or displayed on a client system 114 (e.g., via interface module 122, etc.) of the initial user. The acquiring user may subsequently proceed to provide offers for other items in substantially the same manner described above (FIG. 4).

When an offer from an acquiring user is rejected by the initial user (e.g., detection of actuation of a reject actuator on a user interface of a client system 114) as determined at operation 520, management module 116 notifies the acquiring user of the rejection at operation 575. The notification may indicate any information pertaining to the rejection of the offer (e.g., time of the rejection, reason for the rejection obtained from the initial user, etc.), and may be presented or displayed on a client system 114 (e.g., via interface module 122, etc.) of the acquiring user. The acquiring user may subsequently proceed to provide offers for other items in substantially the same manner described above (FIG. 4).

When the offer remains pending (e.g., the offer has not been canceled, rejected, or accepted) as determined at operation 525, the group of onchain and/or offchain assets (e.g., wallet and/or offchain accounts) provided by the acquiring user are continuously or continually monitored until the offer is finalized (e.g., accepted, rejected, withdrawn/canceled, etc.). In addition, the confidence score may be continuously or continually updated and displayed as the group of assets (or accounts) are monitored and the valuation changes. For example, management module 116 (e.g., via smart contracts 146, decentralized application (dApp) 148, and/or blockchain related application 160, etc.) scans the connected wallet accounts by the acquiring user for onchain assets, and retrieves and analyzes corresponding blockchain transactions for the onchain assets to determine a valuation of the onchain assets in substantially the same manner described above.

Management module 116 may access various offchain accounts containing funds or other assets (e.g., bank or other financial accounts, stock or equity portfolios, etc.) to determine a valuation of the offchain assets in substantially the same manner described above. Thus, the valuation may be determined at operation 530 based on values of onchain assets (e.g., cryptocurrencies, non-fungible tokens (NFTs), etc.) and/or offchain assets (e.g., domains, financial accounts, etc.) of the acquiring user. The valuation (and confidence score) may be determined and presented or displayed to the acquiring user (on a user interface of a client system 114).

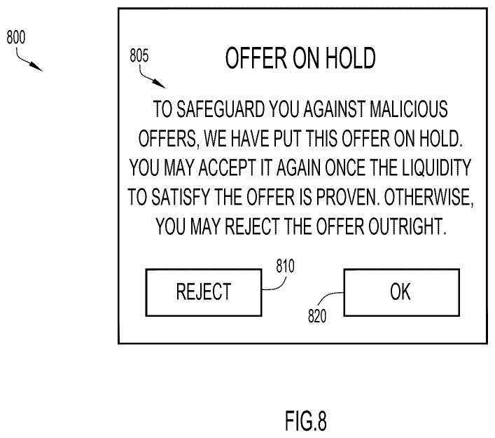

When the valuation does not satisfy the value indicated in the offer (e.g., the valuation is less than the value indicated in the offer, etc.) as determined at operation 535, management module 116 places the offer on hold (or suspends the offer) at operation 540 and prevents acceptance of the offer by the initial user. For example, a flag or parameter may be set indicating the offer is suspended or on hold to prevent acceptance of the offer (and processing or execution of a blockchain transaction to transfer the item). A notification of the hold may be generated by management module 116 and presented or displayed to the initial user (via a client system 114) at operation 545. The notification may indicate any information pertaining to the hold (e.g., valuation, assets of the acquiring user, time of valuation, offer may not be currently accepted, etc.). Further, management module 116 may provide the initial user with an opportunity to reject the offer. The opportunity (and notification) may be provided on a user interface (e.g., as shown in FIG. 8) presented or displayed on a client system 114 at operation 545. When the offer is to be rejected as determined at operation 550 (e.g., via detection of actuation of a reject actuator of the user interface), management module 116 rejects the offer at operation 555. Management module 116 may update the computerized platform of the rejection (e.g., remove the offer, etc.) via any conventional or other techniques.

Further, a notification of insufficient valuation may be generated by management module 116 and presented or displayed to the acquiring user (via a client system 114) at operation 560 when the offer is not rejected as determined at operation 550. The notification may indicate any information pertaining to the insufficient valuation (e.g., valuation, assets of the acquiring user, time of valuation, difference between the valuation and amount indicated in the offer, etc.). Management module 116 may provide the acquiring user with an opportunity to add onchain and/or offchain assets to the group (e.g., an additional wallet and/or offchain account with onchain and/or offchain assets) to increase the valuation and remedy the deficiency. The opportunity (and notification) may be provided on a user interface (e.g., as shown in FIG. 9) presented or displayed on a client system 114. When one or more additional assets (e.g., an additional wallet and/or offchain account) are to be provided as determined at operation 565 (e.g., via detection of actuation of an actuator of the user interface), management module 116 connects to the additional wallet and/or offchain accounts at operation 570 in substantially the same manner described above.

The process repeats from operation 530 to determine the valuation of the group of onchain and/or offchain assets (and confidence score) of the acquiring user in substantially the same manner described above. For example, management module 116 (e.g., via smart contracts 146, decentralized application (dApp) 148, and/or blockchain related application 160, etc.) scans the connected wallet accounts by the acquiring user for onchain assets, and retrieves and analyzes corresponding blockchain transactions for the onchain assets to determine a valuation of the onchain assets in substantially the same manner described above.

Management module 116 may access various offchain accounts containing funds or other assets (e.g., bank or other financial accounts, stock or equity portfolios, etc.) to determine a valuation of the offchain assets in substantially the same manner described above. Thus, the valuation may be determined based on values of onchain assets (e.g., cryptocurrencies, non-fungible tokens (NFTs), etc.) and/or offchain assets (e.g., domains, financial accounts, etc.) of the acquiring user.

The above process repeats from operation 530 until the valuation satisfies the value indicated in the offer as determined at operation 535, or no additional assets (e.g., wallet or offchain accounts, etc.) are provided as determined at operation 565.

When no additional assets (e.g., wallet or offchain accounts) are provided (e.g., the acquiring user actuates a withdraw offer actuator on the user interface requesting additional wallet and/or offchain accounts, etc.) as determined at operation 565, management module 116 cancels or withdraws the offer at operation 575. A notification of the canceled offer may be generated by management module 116 and presented or displayed to the initial user (via a client system 114). The notification may indicate any information pertaining to the offer or cancelation (e.g., time of the cancelation, reason for the cancelation obtained from the acquiring user, etc.). Management module 116 may update the computerized platform of the cancelation (e.g., remove the offer, etc.) via any conventional or other techniques. The acquiring user may subsequently proceed to provide offers for other items in substantially the same manner described above (FIG. 4).

When the valuation satisfies the value indicated in the offer (e.g., the valuation is greater than or equal to the value indicated in the offer, etc.) as determined at operation 535, the above process repeats from operation 515 until finalization of the offer (e.g., acceptance, rejection, cancelation, etc.) in substantially the same manner described above.

When the offer has been accepted by the initial user as determined at operation 525 (e.g., detection of actuation of an accept actuator on the computerized platform, etc.), transfer of the item from the initial user to the acquiring user is performed. Transfer of an onchain or offchain asset may include any action or transaction that provides ownership, rights, registration, custody, control, possession, and/or any other interest in the onchain or offchain asset. Further, acquiring or obtaining an onchain or offchain asset may include obtaining ownership, rights, registration, custody, control, possession, and/or any other interest in the onchain or offchain asset.

In particular, management module 116 (e.g., via smart contracts 146, decentralized applications (dApps) 148, and/or blockchain related applications 160) transfers the value (or amount) indicated in the accepted offer from the acquiring user to the initial user at operation 580. The transfer of the value (e.g., payment, etc.) may include any quantity of onchain and/or offchain assets (e.g., cryptocurrency, non-fungible tokens (NFTs), funds, domains, etc.) having a total valuation corresponding to the value indicated in the accepted offer. Management module 116 may select the onchain and/or offchain assets to transfer based on any criteria (e.g., preferences of the acquiring user, random selection of assets until the value of the offer is satisfied, priority of the onchain and/or offchain assets, in ascending or descending order of value or other attribute (e.g., age, popularity, etc.), etc.).

The transfer of onchain assets (e.g., cryptocurrency, non-fungible tokens (NFTs), etc.) may be accomplished by providing a transaction to the corresponding blockchain in substantially the same manner described above (FIG. 3). For example, management module 116 (e.g., via smart contract 146, decentralized application (dApp) 148, and/or blockchain related application 160) transfers the onchain assets from connected wallet accounts of the acquiring user to a wallet account of the initial user. In the event offchain funds (e.g., funds, stocks or equities, etc.) are used to transfer the value, the offchain funds may be electronically transferred between the acquiring user and initial user (e.g., by access module 152 of offchain asset system 150, etc.) via any conventional or other techniques. Further, offchain domains may be transferred (e.g., via registration module 132 of registration system 130, etc.) in substantially the same manner described below.

Once the onchain and/or offchain assets of the acquiring user for the offer are transferred, the item (e.g., including onchain and/or offchain assets) is transferred from the initial user to the acquiring user at operation 585. In the case the item includes an onchain asset (e.g., tokenized domain name, etc.), the transfer may be accomplished by providing a transaction to the corresponding blockchain in substantially the same manner described above (FIG. 3). For example, management module 116 (e.g., via smart contract 146, decentralized application (dApp) 148, and/or blockchain related application 160) transfers the onchain asset of the item to the acquiring user (e.g., places the onchain asset of the item in a wallet account of the acquiring user). This may be accomplished by management module 116 (e.g., via blockchain related application 160, smart contract 146, and/or decentralized application (dApp) 148) providing a transaction to the blockchain indicating acquisition of the onchain asset (or NFT) of the item by the acquiring user. In addition, various information for the onchain asset of the item (e.g., user information, asset information, wallet information, etc.) may be stored onchain and/or in offchain storage (e.g., database system 118, etc.).

In the event the item includes an offchain asset (e.g., Web2 or DNS domain name, Web2 or DNS domain name corresponding to the onchain asset, etc.), the offchain asset of the item is transferred from the initial user to the acquiring user. By way of example, a Web2 domain may be transferred from an owner registrar account to the registrar account of a user interested in obtaining the domain. However, the transfer process is not instantaneous and can involve several operations and delays.

In order to commence the transfer, the owner ensures that the domain is unlocked at their registrar. This is typically accomplished by logging into the registrar control panel and disabling any locks that prevent unauthorized transfers. Registrar locks are in place to prevent domain theft or accidental transfers, and unlocking a domain requires action from the owner. This unlocking operation occurs before initiating the transfer to the user interested in obtaining the domain.

Once the domain is unlocked, the owner provides an authorization code (e.g. an Extensible Provisioning Protocol (EPP) code, etc.) to the interested user. This code is required by the registrar of the interested user to approve and complete the transfer. The owner can obtain this code by requesting the code from their registrar, and once the interested user has the code, the interested user can initiate the transfer process on their own registrar platform.

The domain transfer process can endure from a few hours to several days. The standard transfer period is usually between five to seven days, but in some cases, it can take up to sixty days, depending on various factors. The sixty day waiting period is particularly relevant in cases where the domain was recently registered or transferred. According to the Internet Corporation for Assigned Names and Numbers (ICANN) rules, newly registered or recently transferred domains are subject to a sixty day lock period during which they cannot be transferred to another registrar. For example, if the Web2 domain was registered or transferred to the owner within the last sixty days, the owner may not be able to transfer the domain to the interested user until this lock expires. This policy is designed to reduce domain hijacking and fraudulent transfers.

Once the transfer is initiated and all necessary confirmations are made (e.g., the authorization code, the unlock status, etc.), the interested user receives a confirmation email from their registrar, and the domain is transferred to the account of the interested user. After the transfer is complete, the interested user can renew the domain or manage the domain within their registrar control panel.

Following a successful transfer, the new owner may need to update the domain WHOIS information (contact details) and may also establish domain privacy protection.

Management module 116 may send a request to registration module 132 of registration system 130. The request may indicate to edit or modify DNS or other records for the offchain asset of the item at a current registrar to transfer the offchain asset of the item to the acquiring user (using the same registrar).

Alternatively, a request for the offchain asset of the item to be transferred (to a new registrar) may be sent from registration system 130 to client system 114 of the initial user. The initial user performs the transfer process (e.g., with respect to unlocking and authorization codes) for management of the offchain asset of the item in a new registrar. The offchain asset of the item may be transferred to a registrar of choice of the acquiring user. The contact information (for the acquiring user) may be required as part of the transfer process for the offchain asset of the item and provided by the acquiring user (via client system 114) to registration system 130.

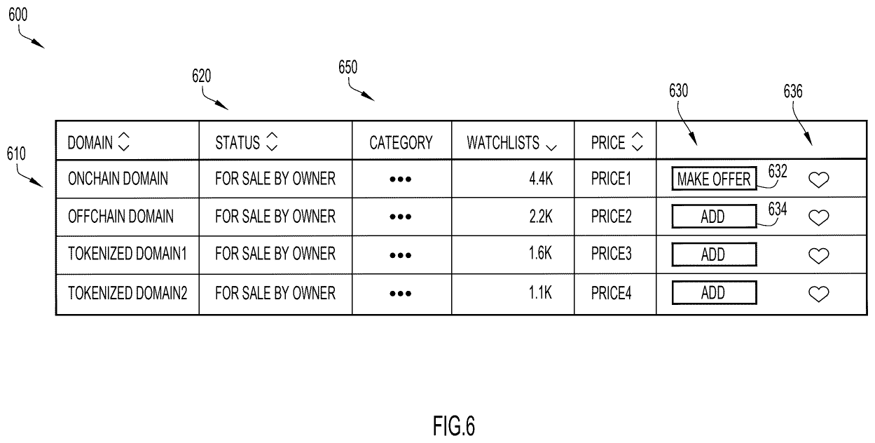

An example scenario for controlling a blockchain transaction based on continuous monitoring of fluctuating (or varying) values of assets for the blockchain transaction according to an embodiment of the present invention is illustrated in FIG. 6-9. Initially, an acquiring user navigates (via a client system 114) to a user interface of a computerized platform (managed by management module 116) providing available items including onchain and/or offchain assets. Referring to FIG. 6, an example user interface 600 of the computerized platform presents available items including onchain and/or offchain assets in the form of a table 650. The table includes rows 610 each corresponding to an item and columns 620 each corresponding to an attribute or field for the items of the rows. By way of example, the items of rows 610 may correspond to domains and include an onchain domain (e.g., ONCHAIN DOMAIN as viewed in FIG. 6), an offchain (or DNS) domain (e.g., OFFCHAIN DOMAIN as viewed in FIG. 6), a first tokenized domain (e.g., TOKENIZED DOMAIN1 as viewed in FIG. 6), and a second tokenized domain (e.g., TOKENIZED DOMAIN2 as viewed in FIG. 6), while columns 620 may include a domain field, a status field, a category field, a watchlist field, and a price field. The domain field indicates the domain name, while the status field indicates an availability status. The category field indicates a category or type for the domain, while the watchlist field indicates a quantity of users interested in (or watching) the domain. The price field indicates a price for the domain.

Each row 610 further includes a transaction actuator 630 and a favorite actuator 636. Transaction actuator 630 may include an offer actuator 632 or an add actuator 634 depending on the preference of the owner of the domain. For example, an owner may desire to consider offers for the domain. In this case, a row 610 corresponding to the domain includes offer actuator 632 to enable an acquiring user to submit an offer for the domain. Further, an owner of a domain may desire to receive the listed price. In this case, a row 610 corresponding to the domain includes add actuator 634 to enable a transaction to be conducted for an acquiring user to obtain the domain for the listed price. Favorite actuator 636 may be actuated to indicate a favorite or preferred domain of a user.

The acquiring user may place an offer on a domain (of an owner or an initial user) listed on the computerized platform (e.g., ONCHAIN DOMAIN of FIG. 6) by actuating a corresponding offer actuator 632 of user interface 600. By way of example, the offer may indicate a value for the domain of $5,000. The acquiring user connects a wallet account with a balance or asset valuation of $1,000. Since the balance or asset valuation of the wallet account is less than the amount of the offer, an error message is generated by management module 116 and presented or displayed to the acquiring user indicating that the valuation of assets of the wallet account does not satisfy the amount of the offer. Referring to FIG. 7, an example dialog box or screen 700 may be presented or displayed to the acquiring user (via a client system 114) when the valuation does not satisfy the amount of the offer. Screen 700 includes a message area 705, a cancel actuator 710, and a continue (OK) actuator 720. Message area 705 may include any text or other media to indicate an insufficient balance or asset valuation to cover the amount indicated in the offer (e.g., “Proof of Funds Error, You must hold at least $5 k in assets to cover the $5 k offer.” as viewed in FIG. 7). Cancel actuator 710 enables cancelation of the offer, while continue actuator 720 acknowledges the situation and enables the process to continue to remedy the insufficiency. For example, another dialog box or screen (e.g., similar to FIG. 9) may be presented to facilitate connecting another wallet account of the acquiring user in substantially the same manner described above.

The acquiring user actuates continue actuator 720 and proceeds to connect another wallet account. By way of example, the other wallet account has a balance or asset valuation of $10,000. In this case, the total valuation of assets in the connected wallet accounts ($1000+$10,000=$11,000) exceeds the amount of the offer ($5,000), and the offer is submitted for the domain in substantially the same manner described above.

However, prior to acceptance of the offer by the initial user, the valuation of the assets in the connected wallet accounts may change. For example, the acquiring user may withdraw $4,000 from a connected wallet account, and transfer $3,000 in non-fungible tokens (NFTs) from that connected wallet account to another wallet account. Thus, the valuation of the assets of the connected wallet accounts is reduced to an amount (e.g., $11,000−$4000−$3000=$4000) below the amount of the offer ($5,000).

Further, the connected wallet accounts may contain assets whose values continuously vary or fluctuate. For example, cryptocurrencies and non-fungible tokens (NFTs) have values that vary or fluctuate over time and, therefore, change the valuation of assets in the connected wallet accounts. By way of example, these types of assets may fluctuate and reduce the asset valuation to $4,000.

In these cases where the asset valuation of the connected wallet accounts becomes less than the amount indicated in the offer, the initial user or owner of the domain is presented with a warning that the offer cannot be accepted until proof of funding is satisfied. Referring to FIG. 8, an example dialog box or screen 800 may be presented to the owner or initial user (via a client system 114) when the valuation of assets in the connected wallets account drops below the amount of the offer. Screen 800 includes a message area 805, a reject actuator 810, and a continue (OK) actuator 820. Message area 805 may include any text or other media to indicate an offer is on hold (or suspended) due to an insufficient balance or asset valuation to cover the amount indicated in the offer (e.g., “Offer on Hold, To safeguard you against malicious offers, we have put this offer on hold. You may accept it again once the liquidity to satisfy the offer is proven. Otherwise, you may reject the offer outright.” as viewed in FIG. 8). Reject actuator 810 enables the initial user to reject the offer, while continue actuator 820 enables the process to continue and provide an opportunity for the acquiring user to remedy the insufficiency (e.g., connect another wallet account, etc.).

In addition, the acquiring user also receives an alert pertaining to an insufficient valuation of the assets of the connected wallet accounts. Referring to FIG. 9, an example dialog box or screen 900 may be presented to the acquiring user (via a client system 114) when the valuation of the connected wallet accounts drops below the amount of the offer. Screen 900 includes a message area 905, a cancel or withdraw actuator 910, and a proof actuator 920. Message area 905 may include any text or other media to indicate an insufficient balance or asset valuation to cover the amount indicated in the offer (e.g., “Proof of Funds Error, Your proof of funds balance dropped below the offer value. Click to add additional proof or withdraw offer.” as viewed in FIG. 9). Withdraw actuator 910 enables cancelation of the offer, while proof actuator 920 enables the acquiring user to remedy the insufficiency by connecting another wallet account in substantially the same manner described above.

When the additional connected wallet account enables the asset valuation to satisfy the amount indicated in the offer, management module 116 generates and sends a message to the initial user indicating that the offer may be accepted (e.g., the offer is released and no longer placed on hold, etc.). The initial user accepts the offer on the computerized platform (e.g., via an actuator on a user interface of a client system 114), and the amount indicated in the offer is transferred to the initial user, while the domain is transferred to the acquiring user in substantially the same manner described above.

In addition, the valuation may be based on offchain assets, or a combination of onchain and offchain assets (e.g., a bank account may be connected with an offchain balance, a DNS domain name, etc.) in substantially the same manner described above.

Thus, present invention embodiments constantly monitor (e.g., in real-time or near real-time) a group of onchain and/or offchain assets (e.g., wallet accounts, other sources of onchain and/or offchain assets, etc.) supporting the offer that may fluctuate or vary over time. This enables control of blockchain transactions to ensure the acquiring user can satisfy the offer prior to commencing the blockchain transaction. For example, blockchain transactions may be suspended or prevented when the valuation of assets drops below the amount in the offer, and enabled when the valuation satisfies the amount in the offer. This ensures appropriate transactions are processed or performed (and entered) on a blockchain for transfer of items.

Present invention embodiments may provide various technical and other advantages. For example, present invention embodiments provide enhanced manners of accessing an asset, and enable use of asset identifiers (and access of corresponding assets) across different networks (e.g., DNS and blockchain, etc.). Present invention embodiments enable transactions using any of the corresponding offchain and onchain identifiers or domain names, thereby providing new functionality to an identifier of a network that is absent on that network (e.g., send cryptocurrency to a centralized or Web2 domain name, etc.). For example, an acquiring user may provide an onchain domain to connect to or access an offchain account, and an offchain domain to connect to or access a wallet account.

Further, present invention embodiments provide enhanced security for blockchain transactions for items. This ensures valid transactions are submitted to the blockchain systems (prior to validation by the blockchain systems) to improve computer performance and throughput of the transactions by avoiding additional processing for invalid transactions. For example, present invention embodiments provide multiple levels of security for a blockchain transaction and flexibility (e.g., wallet verification, asset valuation, etc.). Initially, an acquiring user may indicate a wallet and/or offchain account for an offer. These accounts are verified by a wallet signature, credentials, etc. This ensures the validity of the accounts and acquiring user. Further, submission of the offer is controlled based on valuation of the wallet and/or offchain accounts satisfying the offer. This prevents submission of offers with insufficient assets that could unnecessarily flood the platform and/or erroneously be processed.

Further, once the offer is submitted, the value of the assets are monitored in real-time to ensure their value satisfies the offer. This also provides the acquiring user with flexibility to conduct activity (e.g. transactions/transfer the assets, etc.) with the wallet and/or offchain accounts (unlike an escrow account where assets are frozen), while ensuring the value of the assets satisfy the offer. Present invention embodiments verify acquiring users ability to satisfy amounts of the transactions over time (e.g., as assets of the acquiring user fluctuate over time between offer and acceptance). This is accomplished by monitoring over time (e.g., between offer and acceptance) assets of the acquiring user in real-time to ensure the value of the assets satisfies the transactions. Moreover, a confidence score for the acquiring user is updated and displayed in real-time based on the real-time valuations. Thus, the blockchain transaction (e.g., to transfer the item) is controlled, such that the blockchain transaction is prevented when the valuation of the assets drops below the amount of the offer at any time between offer and acceptance. This prevents improper blockchain transactions from being processed and stored on the blockchain that unnecessarily consume processing resources and suspend the asset with respect to other offers.

It will be appreciated that the embodiments described above and illustrated in the drawings represent only a few of the many ways of implementing embodiments for controlling blockchain transactions based on fluctuating asset values. In addition, characteristics or features of embodiments of the present invention may be combined in any fashion to provide additional embodiments of the present invention.

The environment of the present invention embodiments may include any number of computer or other processing systems (e.g., client or end-user systems, server systems, registration systems, blockchain systems, offchain asset systems, etc.) and databases or other repositories arranged in any desired fashion, where the present invention embodiments may be applied to any desired type of computing environment (e.g., cloud computing, client-server, network computing, mainframe, stand-alone systems, etc.). The computer or other processing systems employed by the present invention embodiments may be implemented by any number of any personal or other type of computer or processing system (e.g., desktop, laptop, hand-held devices, smartphones or other mobile devices, etc.), and may include any commercially available operating system and any combination of commercially available and custom software (e.g., communications software; server software; software of present invention embodiments (including management module 116, interface module 122, registration module 132, smart contracts 146, decentralized applications (dApps) 148, access module 152, blockchain related applications 160, etc.); etc.). These systems may include any types of monitors and input devices (e.g., keyboard, mouse, voice recognition, etc.) to enter and/or view information.

It is to be understood that the software of the present invention embodiments (e.g., management module 116, interface module 122, registration module 132, smart contracts 146, decentralized applications (dApps) 148, access module 152, blockchain related applications 160, etc.) may be implemented in any desired computer language and could be developed by one of ordinary skill in the computer arts based on the functional descriptions contained in the specification and flowcharts illustrated in the drawings. Further, any references herein of software performing various functions generally refer to computer systems or processors performing those functions under software control. The computer systems of the present invention embodiments may alternatively be implemented by any type of hardware and/or other processing circuitry.

The various functions of the computer or other processing systems may be distributed in any manner among any number of software and/or hardware modules or units, processing or computer systems and/or circuitry, where the computer or processing systems may be disposed locally or remotely of each other and communicate via any suitable communications medium (e.g., LAN, WAN, Intranet, Internet, hardwire, modem connection, wireless, etc.). For example, the functions of the present invention embodiments may be distributed in any manner among the various end-user/client, server, registration, and blockchain systems, and/or any other intermediary processing devices. The software and/or algorithms described above and illustrated in the flowcharts may be modified in any manner that accomplishes the functions described herein. In addition, the functions in the flowcharts or description may be performed in any order that accomplishes a desired operation.

The software of the present invention embodiments (e.g., management module 116, interface module 122, registration module 132, smart contracts 146, decentralized applications (dApps) 148, access module 152, blockchain related applications 160, etc.) may be available on a non-transitory computer useable or readable medium (e.g., magnetic or optical mediums, magneto-optic mediums, CD-ROM, DVD, memory devices, etc.) of a stationary or portable computer program product, apparatus, or device for use with stand-alone systems or systems connected by a network or other communications medium. The computer usable or readable medium (or media) may include instructions executable by one or more processors to perform functions of present invention embodiments described herein.

The communication network may be implemented by any number of any type of communications network (e.g., LAN, WAN, Internet, Intranet, VPN, etc.). The computer or other processing systems of the present invention embodiments may include any conventional or other communications devices to communicate over the network via any conventional or other protocols. The computer or other processing systems may utilize any type of connection (e.g., wired, wireless, etc.) for access to the network. Local communication media may be implemented by any suitable communication media (e.g., local area network (LAN), hardwire, wireless link, Intranet, etc.).

The system may employ any number of any conventional or other databases, data stores or storage structures (e.g., files, databases, data structures, data or other repositories, etc.) to store information (e.g., blockchain asset information, metadata, mappings of blockchain assets to blockchains, preferences, etc.). The database system may be implemented by any conventional or other databases, data stores or storage structures to store information. The database system may be included within or coupled to the server, client, registration, blockchain, and/or offchain asset systems. The database systems and/or storage structures may be remote from or local to the computer or other processing systems, and may store any desired data.

The present invention embodiments may employ any number of any type of user interface (e.g., Graphical User Interface (GUI), command-line, prompt, etc.) for obtaining or providing information (e.g., preferences, offers, results of offers, valuations, confidence scores, notifications, domain or web site content, blockchain asset information, etc.), where the interface may include any information arranged in any fashion. The interface may include any number of any types of input or actuation mechanisms (e.g., buttons, icons, fields, boxes, links, etc.) disposed at any locations to enter/display information and initiate desired actions via any suitable input devices (e.g., mouse, keyboard, etc.). The interface screens may include any suitable actuators (e.g., links, tabs, etc.) to navigate between the screens in any fashion.

A report may include any information arranged in any fashion, and may be configurable based on rules or other criteria to provide desired information to a user (e.g., blockchain assets, status and/or information of onchain and/or offchain assets, offers, accepted offers, rejected offers, valuations, confidence scores, preferences, etc.).

The present invention embodiments are not limited to the specific tasks or algorithms described above, but may be utilized for controlling any blockchain transactions by verifying sufficient conditions exist for satisfying terms the blockchain transactions. For example, the terms may correspond to valuations of any onchain and/or offchain assets for the blockchain transactions.

An asset may include any item or object, and may be associated with a computer or network environment (e.g., a domain, a domain name, a set of records, an object that points to a set of records, a non-fungible token (NFT), non-fungible token (NFT) domain names, a fungible token, a wallet address, email or other service, communication entity, currency, stocks, equities, physical objects, etc.). An onchain asset may include any asset residing on, or supported by, a blockchain or other decentralized system (e.g., Web3 asset, asset of a decentralized system, asset of a partial or hybrid decentralized system, etc.). An offchain asset may include any asset residing on, or supported by, a centralized system or a system with centralized control (e.g., Web2, Domain Name System (DNS), ICANN accredited domain names, system other than a decentralized system described above, etc.). An offchain asset may further include any tangible or intangible objects maintained outside of a blockchain (e.g., currency, stocks, equities, physical objects, etc.). An onchain system may include any blockchain or other decentralized system (e.g., Web3, decentralized system, partial or hybrid decentralized system, etc.), while an offchain system may include any centralized system or system with centralized control (e.g., Web2, Domain Name System (DNS), system other than a decentralized system described above, etc.).

The name or other identifier for the offchain and onchain assets with respect to NFTs or domains may include a name portion and an optional extension (e.g., “name.e1”, etc.). Alternatively, the name or other identifier may include the name portion without the extension. The name portion and extension may each include any quantity of terms, words, tokens, or arrangements of any quantity of any types of elements (e.g., alphanumeric or other characters, symbols, numbers, etc.).

Any quantity of any parameters, values, or other information may be associated with an asset. The information for an offchain asset may include any information arranged in any fashion (e.g., values for domain records, domain parameters, server names or addresses, etc.). Any information of an offchain asset may be stored for an onchain asset to link the assets. This information may be stored on a blockchain and/or on an offchain data source in any storage item (e.g., record, data object, etc.). The information for an onchain asset may include any information arranged in any fashion (e.g., values for asset attributes, blockchain, wallet address, user/owner information etc.). Any information of an onchain asset may be stored for an offchain asset to link the assets. This information may be stored on a blockchain and/or on an offchain data source in any storage item (e.g., record, data object, etc.). The offchain data source may include any storage structure (e.g., decentralized storage structure or platform, blockchain storage, database, etc.). The asset information may be stored and retrieved based on any information (e.g., based on registered user information (e.g., wallet address, blockchain asset, blockchain domain or user name, user information, etc.)).

The onchain assets may be from any desired blockchains. Availability for an onchain asset may be determined by searching any onchain and/or offchain storage for any corresponding records or information indicating existence of the onchain asset on a system. Further, availability for an offchain asset may be determined by searching any onchain and/or offchain storage for any corresponding records or information indicating existence of the offchain asset on a system.

A name of an asset of a system may be used to access any corresponding assets of any other systems. For example, the information for the asset may indicate the information (e.g., names or identifiers, addresses, etc.) of the corresponding assets. The information may be retrieved based on the name of the asset and used to resolve the name of the asset to the location (e.g., system, name, address, etc.) of the corresponding assets on the other systems to access (and/or perform transactions) with respect to those corresponding assets. By way of example, a user may send cryptocurrency (e.g., a loan or other payment) to a Web2 domain name. Further, a user may provide an onchain domain to connect to or access an offchain account, and an offchain domain to connect to or access a wallet account.

A user may include, or be associated with, any type of entity (e.g., individual, company, organization, decentralized autonomous organization (DAO), etc.). Transfer of an onchain or offchain asset may include any action or transaction that provides ownership, rights, registration, custody, control, possession, and/or any other interest in the onchain or offchain asset. Further, an interest may include ownership, rights, registration, custody, possession, control, and/or any other stake or share in the onchain or offchain asset. Moreover, acquiring or obtaining an onchain or offchain asset may include obtaining ownership, rights, registration, custody, control, possession, and/or any other interest in the onchain or offchain asset.

The online or computerized platform may include any platform providing items for transfer. An item may include any onchain asset (e.g., non-fungible token (NFT), NFT representing an offchain asset, blockchain domain name, etc.), any offchain asset (e.g., Web2, ICANN, or Domain Name System (DNS) domain or domain name, etc.), or a combination of onchain and offchain assets (e.g., a tokenized version of an offchain domain name and the corresponding offchain domain name, etc.). An onchain asset (and offchain asset) may be obtained via any type of transaction. Any onchain and/or offchain assets (e.g., cryptocurrencies, NFTs, blockchain domains, DNS or Web2 domains, funds, stocks, equities, financial instruments, etc.) may be used to satisfy an amount of an offer or other terms of a blockchain transaction (e.g., payment, etc.). The assets may be associated with any types of onchain and/or offchain accounts (e.g., wallet accounts, bank or financial accounts, etc.). The accounts may be accessed via any authorizations or credentials (e.g., username, password, security token, wallet signature, etc.).

The valuation (or monitoring of a group of assets) may be performed at any desired time intervals (e.g., periodically at any time periods, scheduled, at certain times, etc.). The value of a group of assets may be determined from the accounts or any other data sources (e.g., network sites, etc.). The confidence score may be based on any criteria. The criteria may be combined in any fashion to determine the confidence score (e.g., summed, averaged, weighted sums or average, etc.). The initial user may utilize the confidence score as a basis to reject or accept an offer. The confidence score may be updated when the valuation is performed. This provides constant updates to indicate the changing strength of the offer (and likelihood the transaction can be performed).

An acquiring user may provide or indicate any quantity of groups of any quantity of onchain and/or offchain assets to satisfy the amount of an offer or other terms of a transaction. A group may include or correspond to any collection, set, account, or other corpus of assets. The transfer of an onchain asset may be accomplished via any blockchain or other transaction. For example, the transfer may be accomplished by conducting a transaction on the blockchain to indicate transfer of the onchain asset to a new owner. Further, transfer of an offchain asset of a computer environment may be accomplished by modifying any corresponding records of the offchain asset (e.g., Domain Name System (DNS) records, etc.). Moreover, access to the records of the offchain asset may be accomplished by modifying any corresponding records of the offchain asset (e.g., Domain Name System (DNS) records, etc.), and may be performed in response to transfer of the offchain asset.

The onchain and/or offchain assets of a group used to tender payment for an offer may be selected based on any criteria. For example, a user may indicate preferences with respect to which onchain and/or offchain assets of the group to utilize for valuation and payment. When a deficiency occurs, additional onchain and/or offchain assets of the group may be added for the valuation and payment. Further, the onchain and/or offchain assets of the group may be selected randomly until the value of the offer is satisfied. Moreover, the onchain and/or offchain assets of the group may be assigned and selected based on priority. In addition, the onchain and/or offchain assets of the group may be selected in ascending or descending order of value or other attribute (e.g., age, popularity, etc.), etc.) until the value of the offer is satisfied.

The offer is preferably in electronic form (e.g., online, electronic document, electronic record, etc.), but may be of any form. Further, the offer may be generated, submitted, displayed, accepted, rejected, and/or canceled in any conventional or other fashion. In addition, the offer may include any information arranged in any fashion (e.g., listed item information, amount or value to be provided for the listed item, acquiring user information, initial user information, platform information, transaction information, contact information, asset/account information for the amount, etc.).

Corresponding assets of the computer environment (e.g., onchain and corresponding offchain assets, etc.) may be the same or different types of assets, and may be on the same or different types of systems (e.g., centralized, decentralized, etc.).

Having described preferred embodiments of a new and improved system, method, and computer program product for controlling blockchain transactions based on fluctuating asset values, variations and changes will be suggested to those skilled in the art in view of the teachings set forth herein. It is therefore to be understood that all such variations, modifications and changes are believed to fall within the scope of present invention embodiments as defined by the appended claims.

What is claimed is:

1. A method of transferring items of a computer environment comprising:
generating for a user, via at least one processor, an electronic offer for an item of the computer environment, wherein the electronic offer includes an amount for the item;
determining, via the at least one processor, that a group of one or more assets of the user has a valuation to satisfy the amount of the electronic offer, wherein the valuation of the group fluctuates over time;
submitting, via the at least one processor, the electronic offer to acquire the item;
monitoring, via the at least one processor, the group and updating the valuation over time prior to transfer of the item; and
controlling, via the at least one processor, a blockchain transaction to transfer the item to the user based on a comparison of the updated valuation to the amount of the electronic offer.

2. The method of claim 1, wherein the item includes one of an onchain asset, an offchain asset, and a combination of a tokenized offchain asset and corresponding offchain asset.

3. The method of claim 1, wherein the one or more assets include one or more from a group of cryptocurrency and non-fungible tokens.

4. The method of claim 1, wherein the group includes at least one onchain asset, and the method further comprises:
connecting to at least one wallet account of the user containing the at least one onchain asset, via the at least one processor, to determine and update the valuation.

5. The method of claim 4, wherein the group further includes at least one offchain asset, and the method further comprises:
accessing at least one offchain account of the user containing the at least one offchain asset, via the at least one processor, to determine and update the valuation.

6. The method of claim 1, wherein updating the valuation comprises:
updating a confidence score for the electronic offer indicating a likelihood that valuation of the group at acceptance satisfies the amount of the electronic offer.

7. The method of claim 1, wherein controlling the blockchain transaction comprises:
suspending the electronic offer, via the at least one processor, to prevent the blockchain transaction from transferring the item to the user when the updated valuation becomes less than the amount of the electronic offer.

8. The method of clam 7, wherein controlling the blockchain transaction further comprises:
identifying, via the at least one processor, at least one additional group with at least one asset of the user to increase the updated valuation when the updated valuation becomes less than the amount of the electronic offer.

9. A system for transferring items of a computer environment comprising:
one or more memories; and
at least one processor coupled to the one or more memories, the at least one processor configured to:
generate for a user an electronic offer for an item of the computer environment, wherein the electronic offer includes an amount for the item;
determine that a group of one or more assets of the user has a valuation to satisfy the amount of the electronic offer, wherein the valuation of the group fluctuates over time;
submit the electronic offer to acquire the item;
monitor the group and update the valuation over time prior to transfer of the item; and
control a blockchain transaction to transfer the item to the user based on a comparison of the updated valuation to the amount of the electronic offer.

10. The system of claim 9, wherein the item includes one of an onchain asset, an offchain asset, and a combination of a tokenized offchain asset and corresponding offchain asset.

11. The system of claim 9, wherein the one or more assets include one or more from a group of cryptocurrency and non-fungible tokens.

12. The system of claim 9, wherein the group includes at least one onchain asset, and the at least one processor is further configured to:
connect to at least one wallet account of the user containing the at least one onchain asset to determine and update the valuation.

13. The system of claim 12, wherein the group further includes at least one offchain asset, and the at least one processor is further configured to:
access at least one offchain account of the user containing the at least one offchain asset to determine and update the valuation.

14. The system of claim 9, wherein updating the valuation of the group comprises:
updating a confidence score for the electronic offer indicating a likelihood that valuation of the group at acceptance satisfies the amount of the electronic offer.

15. The system of claim 9, wherein controlling the blockchain transaction comprises:
suspending the electronic offer to prevent the blockchain transaction from transferring the item to the user when the updated valuation becomes less than the amount of the electronic offer.

16. The system of clam 15, wherein controlling the blockchain transaction further comprises:
identifying at least one additional group with at least one asset of the user to increase the updated valuation when the updated valuation becomes less than the amount of the electronic offer.

17. A computer program product for transferring items of a computer environment, the computer program product comprising one or more non-transitory computer readable media having instructions stored thereon, the instructions executable by at least one processor to cause the at least one processor to:
generate for a user an electronic offer for an item of the computer environment, wherein the electronic offer includes an amount for the item;
determine that a group of one or more assets of the user has a valuation to satisfy the amount of the electronic offer, wherein the valuation of the group fluctuates over time;
submit the electronic offer to acquire the item;
monitor the group and update the valuation over time prior to transfer of the item; and
control a blockchain transaction to transfer the item to the user based on a comparison of the updated valuation to the amount of the electronic offer.

18. The computer program product of claim 17, wherein the item includes one of an onchain asset, an offchain asset, and a combination of a tokenized offchain asset and corresponding offchain asset.

19. The computer program product of claim 17, wherein the one or more assets include one or more from a group of cryptocurrency and non-fungible tokens.

20. The computer program product of claim 17, wherein the group includes at least one onchain asset, and the instructions further cause the at least one processor to:
connect to at least one wallet account of the user containing the at least one onchain asset to determine and update the valuation.

21. The computer program product of claim 20, wherein the group further includes at least one offchain asset, and the instructions further cause the at least one processor to:
access at least one offchain account of the user containing the at least one offchain asset to determine and update the valuation.

22. The computer program product of claim 17, wherein updating the valuation of the group comprises:
updating a confidence score for the electronic offer indicating a likelihood that valuation of the group at acceptance satisfies the amount of the electronic offer.

23. The computer program product of claim 17, wherein controlling the blockchain transaction comprises:
suspending the electronic offer to prevent the blockchain transaction from transferring the item to the user when the updated valuation becomes less than the amount of the electronic offer.

24. The computer program product of clam 23, wherein controlling the blockchain transaction further comprises:
identifying at least one additional group with at least one asset of the user to increase the updated valuation when the updated valuation becomes less than the amount of the electronic offer.
